(19) United States
(12) Patent Application Publication
(10) Pub. No.: US 2020/0305470 A1
(43) Pub. Date: Oct. 1, 2020

(54) Organic Energy Drink

(71) Applicants: Mo Tadaie, Anaheim, CA (US); Ashkan Tadaie, Anaheim, CA (US); Arya Tadaie, Anaheim, CA (US); Fariba Peivandeh, Anaheim, CA (US)

(72) Inventors: Mo Tadaie, Anaheim, CA (US); Ashkan Tadaie, Anaheim, CA (US); Arya Tadaie, Anaheim, CA (US); Fariba Peivandeh, Anaheim, CA (US)

(21) Appl. No.: 16/701,374

(22) Filed: Dec. 3, 2019

Related U.S. Application Data
(60) Provisional application No. 62/826,866, filed on Mar. 29, 2019.

(51) Int. Cl. A23L 2/38; A23L 2/60; A23L 33/00; A23L 33/105; A23L 29/00

(52) U.S. Cl. CPC A23L 2/38; A23L 2/60; A23L 29/035; A23L 33/105; A23L 33/40

(57) ABSTRACT

A healthy, filling, organic energy drink, the ingredients of which will bring energy, curb the appetite, and cleanse the digestive tract, and promote healthy weight loss without the use of caffeine. Based on a tried-and-true old family recipe, the Organic Energy Drink would offer consumers a healthy energy boost, without the caffeine with which other energy drinks are loaded.

### CROSS-REFERENCE TO RELATED APPLICATION

The present application is related to and claims priority from prior provisional application Ser. No. 62/826,866, filed Mar. 29, 2019 which application is incorporated herein by reference

### BACKGROUND OF THE INVENTION

### 1. Field of the Invention

The present invention relates generally to the field of beverages and more specifically relates to a healthy, filling, organic energy drink, the ingredients of which will bring energy, curb the appetite, and cleanse the digestive tract, and promote healthy weight loss without the use of caffeine.

### 2. Description of the Related Art

Virtually everyone at some point in the course of their day, finds their energy level falling, their concentration wandering, their motivation slipping—we all, in other words, need a little boost, a jump-start from time to time. For some, a cup of coffee and a candy bar may help; but too much coffee will leave you with the jitters, and the sugar rush may fade. The invention to be introduced and explored in this report, however, promises hours of high energy, concentration, and motivation, as well as several distinct health benefits with no jitters, and no letdown at the end.

Various attempts have been made to solve the problems which may be found in the related art but have thus far been unsuccessful. A need exists for a reliable Organic Energy Drink to avoid the above-mentioned problems.

### BRIEF SUMMARY OF THE INVENTION

In view of the foregoing disadvantages inherent in the known beverage art, the present invention provides a novel Organic Energy Drink. The general purpose of the present invention, which will be described subsequently in greater detail, is to provide a healthy, filling, organic energy drink, the ingredients of which will bring energy, curb the appetite, and cleanse the digestive tract, and promote healthy weight loss without the use of caffeine. Based on a tried-and-true old family recipe, the Organic Energy Drink would offer consumers a healthy energy boost, without the caffeine with which other energy drinks are loaded. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, Organic Energy Drink, constructed and operative according to the teachings of the present invention.

FIG. 1 shows a perspective view illustrating a Organic Energy Drink according to an embodiment of the present invention.

FIG. 2 shows a perspective view illustrating a flowchart of the ingredients of the Organic Energy Drink according to an embodiment of the present invention.

FIG. 3 shows a perspective view illustrating the liquid composition of the Organic Energy Drink according to an embodiment of the present invention.

The various embodiments of the present invention will hereinafter be described in conjunction with the appended drawings.

### DETAILED DESCRIPTION

As discussed above, embodiments of the present invention relate to a beverage and more particularly to an Organic Energy Drink, a healthy, filling, organic energy drink, the ingredients of which will bring energy, curb the appetite, and cleanse the digestive tract, and promote healthy weight loss without the use of caffeine. Based on a tried-and-true old family recipe, the Organic Energy Drink would offer consumers a healthy energy boost, without the caffeine with which other energy drinks are loaded.

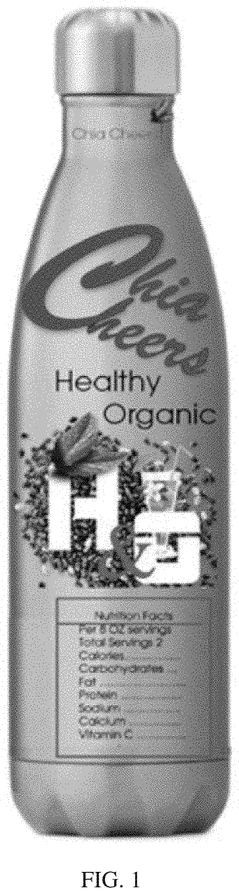

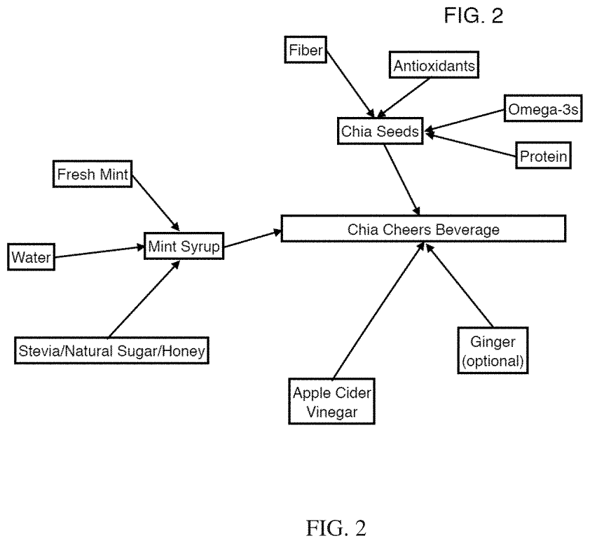

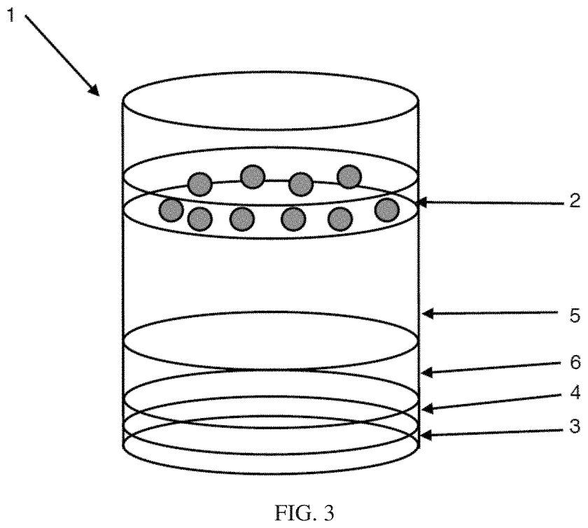

Referring now to the drawings FIGS. 1-3, the Organic Energy Drink comprising a novel product offering consumers a practical solution to the aforementioned challenges. As the name implies, the Organic Energy Drink is an all organic energy drink created to promote weight loss, instill energy and alertness, curb the appetite while cleansing the digestive system, and taste great without using caffeine. With the Organic Energy Drink, there are no “caffeine jitters,” nor any let down after effects, just satisfying flavor, and higher sustained energy while providing health benefits.

Based on an old family recipe, the ingredients of the Organic Energy Drink 1 are as follows: (1) organic Chia Seeds 2, a source of protein which contains fiber, antioxidants, Omega-3's, calcium, iron, and vitamin C, and acts to curb the appetite and produce a feeling of fullness; (2) organic, unpasteurized apple cider vinegar 3, which acts to cleanse the digestive system and increase energy while decreasing cholesterol; (3) mint syrup 4; (4) water 5; and (5) stevia or a natural sugar 6, which give the Organic Energy Drink its distinctive flavor while also increases energy.

More specifically, a single serving of the beverage 1 would include 8 oz sugar or organic stevia, or organic raw honey 6, 12 oz of Purified water or PH balance water 5, 1½ oz of organic apple cider vinegar 3 (unfiltered, unheated, unpasteurized and 5% acidity), 6 stems of fresh mint, 2½ oz of mint syrup 4, and 1½ oz of chia seeds 2.

PH balanced water has a neutral PH. The mint syrup 4 is made by boiling sugar (or organic stevia or honey) 6 in some water 5, and after it melts, adding a whole mint stem(s) 7 with leaves attached. Organic apple cider vinegar 3 may also be added to the minty syrup, and the precise measurements may vary in order to adjust the flavors of the drink. This beverage must be refrigerated once it has been made for optimum taste/health benefits.

The Organic Energy Drink, would deliver nutrition as follows: Calories: 115 per 30 milliliter serving, Protein: 5 grams, 10% of Daily Requirement, Total Fat: 0 grams, Sodium: 0 grams, Potassium: 11 grams, Sugar: 10 grams his proprietary recipe is not to be altered, tampered with, nor added to, with the exception of ginger, which may be added to the drink.

In the Organic Energy Drink, consumers would have an all-organic, caffeine-free, gluten-free alternative to the other, caffeine-heavy energy drinks on the market: an energy drink that would leave them feeling good and energized, alert and motivated, while lowering their cholesterol and cleansing their digestive system, leaving them without the negative effects that caffeinated energy drinks produce.

Upon reading this specification, it should be appreciated that, under appropriate circumstances, considering such issues as user taste and nutritional preferences, combination of seed preference, coloring of the beverage liquid, marketing preferences, cost, available ingredients, etc., other optional ingredient combination such as, for example may include but are not limited to Saffron, ginger, rose, Mugwort Seeds (Artemisia Vulgaria), flaxseeds or any other liquid or seeds may be sufficient.

The Organic Energy Drink is cost-effective to produce in the embodiments, as shown in FIG. 1-3.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. An energy beverage comprising:
(a) chia seeds;
(b) apple cider vinegar;
(c) fresh mint leaves;
(d) a natural sweetener chosen from the group consisting of stevia, cane sugar, and honey; and
(e) water,
wherein the combination of chia seeds, apple cider vinegar, fresh mint, sweetener and water does not exceed 115 calories and 10 grams of sugar per 30 milliliter serving.

2. The energy beverage according to claim 1, wherein the water is purified water or PH balanced water.

3. The energy beverage according to claim 1, wherein the apple cider vinegar is unfiltered, unheated, unpasteurized, and has an acidity of 5%.

4. The energy beverage according to claim 1, further comprising:
(f) ginger root.

5. A single serving of an energy drink, comprising:
(a) 8 oz of a natural sweetener chosen from the group consisting of organic stevia, organic cane sugar or organic raw honey;
(b) 12 oz of purified water or PH balanced water;
(c) 1.5 oz of organic apple cider vinegar, wherein the apple cider vinegar is unfiltered, unheated, unpasteurized, and has an acidity of 5%;
(d) 6 stems of fresh mint;
(e) 2.5 oz of mint syrup, wherein the mint syrup is a strained solution including
(i) a dissolved sweetener;
(ii) fresh mint leaves; and
(iii) water; and
(f) 1.5 oz of chia seeds,
wherein the combination of chia seeds, apple cider vinegar, fresh mint, sweetener, mint syrup, and water does not exceed 115 calories and 10 grams of sugar per 30 milliliter serving.
